(19) United States
(12) Patent Application Publication
(10) Pub. No.: US 2017/0036168 A1
(43) Pub. Date: Feb. 9, 2017

(54) Side Stream Flow Type Reverse Osmosis Membrane Filter

(71) Applicants: PICOGRAM CO., LTD., Gyeonggi-do (KR); PICOLEAD (BEIJING) WATER TREATMENT TECHNOLOGY CO., LTD., Beijing (CN); A.O.SMITH (NANJING) WATER TREATMENT PRODUCTS CO., LTD., Nanjing (CN)

(72) Inventors: Sung Taek LIM, Gyeonggi-do (KR); Hyun Ki HONG, Incheon (KR); Ju Song HUR, Incheon (KR); Jong Ho KONG, Seoul (KR); Hyun Sup SHIN, Incheon (KR); Tae Ho CHUNG, Seoul (KR); Sue Hyun CHOI, Seoul (KR); Go Eun JEONG, Gyeonggi-do (KR)

(21) Appl. No.: 15/305,332

(22) PCT Filed: Apr. 15, 2015
(86) PCT No.: PCT/KR2015/003755

§ 371 Date: Oct. 19, 2016

(30) Foreign Application Priority Data
Apr. 21, 2014 (KR) 10-2014-0047620
May 29, 2014 (KR) 10-2014-0065225

(51) Int. Cl. B01D 61/02; B01D 61/10; B01D 63/06; C02F 1/44

(52) U.S. Cl. CPC B01D 61/025; C02F 1/441; B01D 61/10; B01D 63/06; B01D 2313/10; C02F 2201/002

(57) ABSTRACT

Disclosed is a side stream flow-type reverse osmosis membrane filter with an increased purified water recovery rate. The filter comprises: a filter housing with a raw water port, a purified water port, and a concentrated water port; an RO filter to purify raw water, thereby sending purified water to an inside thereof and discharging concentrated water, which is filtered out; a central tube for collecting the purified water; a raw water pipe arranged in the central tube and provided with a raw water flow channel in a center portion thereof, with a purified water flow channel formed between the raw water pipe and the central tube; and a raw water distributor for supplying supply a portion of raw water to the upper end of the RO filter and a portion of the raw water the lower end of the RO filter and supplying the purified water to the purified water port.

### TECHNICAL FIELD

The present invention relates to a reverse osmosis membrane filter and more particularly to a side stream flow-type reverse osmosis membrane filter for increasing a purified water recovery rate by increasing an amount of raw water supplied to a reverse osmosis membrane sheet.

### BACKGROUND ART

Generally, reverse osmosis (RO) filters are made of a reverse osmosis membrane having pores of 0.0001 micrometers and are used to filter out various kinds of pathogens and sodium as well as heavy metals such as lead and arsenic. Since raw water flows in a widthwise direction of a reverse osmosis membrane sheet, a residence time during which raw water is in contact with the surface of a reverse osmosis membrane sheet is short.

For this reason, a ratio of an amount of purified water that is filtered by an RO filter and discharged through a purified water port, with respect to a supply amount of raw water, is low (typically, about 3:1). Therefore, RO filters have a problem of having a low purified water recovery rate.

With reference to FIG. 1, a conventional RO filter 1 is a spiral-wound-type module in which various kinds of membranes are spirally wound around a core pipe 4. In the RO filter 1, a raw water spacer 3 is arranged between filter members (hereinafter, referred to as membrane sheets) 2 to form a membrane assembly and the membrane assembly is spirally wound around the central pipe 4. In addition, a coat layer 5 is wrapped around the outer surface of the membrane assembly to maintain the form of an RO filter.

A portion of the raw water that passes through the raw water spacer 3 then permeates through the membrane sheet 2, thereby becoming purified water. The purified water flows along the center of the membrane sheet 2 and follows into the core pipe 4 through passage holes 6 formed in the body of the core pipe 4. The purified water is finally discharged through a purified water port 7 installed at an end of the core pipe 4.

The remaining portion of the raw water that passes through the raw water spacer 3 cannot permeate through the membrane sheets 2, thereby becoming concentrated water. The concentrated water flows along the surface of the raw water spacer 3 and is discharged through a concentrated water port 8 installed at a side portion of the core pipe 4.

FIG. 2 illustrates another conventional RO filter 1. Raw water such as tap water is introduced into the RO filter 1 through raw water ports 1a and 1b installed at an upper end and a lower end of the RO filter 1. The raw water is supplied to the upper and lower ends of the RO filter 1 through openings of upper and lower holders 9 and 10 fixed to the upper and lower ends of the RO filter 1. The raw water is purified by passing through a membrane sheet 2. The purified water flows into a core pipe 4 through passage holes 4 formed in a body of the core pipe 4, thereby being collected in the core pipe 4. Then, the purified water is discharged outside through a purified water port 7 formed at the upper end of the RO filter 1. Concentrated water that is water filtered out by the membrane sheet 2 flows outward in a radial direction of the membrane sheet 2 and is then discharged through a concentrated water port 8.

As illustrated in the drawings, a filter housing is provided with the raw water ports 1a and 1b, through which raw water is introduced into the RO filter, at the upper and lower ends of the filter housing, the purified water port 7 through which purified water is discharged, and the concentrated water port 8 through which the concentrated water is discharged.

For this reason, there is inconvenience that hoses (not shown) have to be connected to respective plural ports of the filter housing H. Furthermore, since the hoses have the same shape and size, there is likelihood that a worker mistakenly connects hoses to wrong ports (for example, a worker may connect a purified water hose to a concentrated water port).

Korean patent Application No. 10-2011-7006005 discloses a spiral-wound-type reverse osmosis membrane.

### DISCLOSURE

### Technical Problem

Accordingly, the present invention has been made keeping in mind the above problems occurring in the prior art, and an object of the present invention is to provide a side stream flow-type reverse osmosis membrane filter that can produce a larger amount of purified water by increasing an amount of raw water supplied to a cylindrical reverse osmosis membrane sheet in a manner of supplying raw water from respective ends of the cylindrical reverse osmosis membrane sheet.

Another object of the present invention is to provide a side stream flow-type reverse osmosis membrane filter structured such that a raw water port, a purified water port, and a concentrated water port are formed at one end of a filter housing, thereby improving workability when a worker connects hoses (or tubes) to the respective ports.

A further object of the invention is to provide a side stream flow-type reverse osmosis membrane filter structured such that a filter housing can be detachably connected to a head connector in a one-touch manner, thereby enabling a user to easily replace a water purification filter.

### Technical Solution

In order to accomplish the above objects, according to one aspect, there is provided a side stream flow-type reverse osmosis membrane filter including:

a filter housing provided with a raw water port, a purified water port, and a concentrated water port at an end thereof;

an RO filter that is accommodated in the filter housing, purifies raw water introduced through the raw water port and sends purified water to an inside thereof, and discharges concentrated water which is filtered out, to an outside thereof;

a central tube that is open an upper end and a lower end thereof, is arranged in a center portion of the RO filter, and collects the purified water which is filtered by the RO filter and introduced thereinto through passage holes formed to extend through a body thereof in a radial direction;

a raw water pipe that is open at an upper end and a lower end thereof, is arranged in the central tube to be spaced from an inner surface of the central tube, has a raw water flow channel in a center portion thereof, and defines a purified water flow channel formed between the raw water pipe and the central tube; and

a raw water distributor installed at the upper ends of the raw water pipe and the central tube, thereby supplying a portion of raw water introduced through the raw water port to an upper end of the RO filter and a portion of the raw water to the raw water pipe to supply the latter to a lower end of the RO filter and supplying the purified water collected in the purified water flow channel to the purified water port.

In order to accomplish the above objects, according to another aspect, there is provided a side stream flow-type reverse osmosis membrane filter including:

a filter housing that is open at an upper end thereof; an RO filter that is accommodated in the filter housing, purifies raw water which is introduced and sends purified water to an inside thereof, and discharges concentrated water which is filtered out to an outside thereof;

a central tube that is open at an upper end and a lower end thereof, is arranged in a center portion of the RO filter, and collects the purified water which is purified by the RO filter and introduced thereinto through passage holes formed to extend through a body thereof in a radial direction;

a raw water pipe that is arranged in the central tube to be spaced from an inner surface of the central tube, is open at an upper end and a lower end thereof, has a raw water flow channel in a center portion thereof, and defines a purified water flow channel formed between the raw water pipe and the central tube;

a raw water distributor installed at the upper ends of the raw water pipe and the central tube, thereby supplying a portion of the raw water which is introduced to an upper end of the RO filter and a portion of the raw water which is introduced to the row water pipe to supply the latter to a lower end of the RO filter and sending the purified water collected in the purified water flow channel to an opening of the filter housing; and

a flow channel switching guide installed in the opening of the filter housing and provided with a raw water introduction hole that is formed at a center portion to the raw water which is introduced to the raw water distributor, a purified water discharge hole that is formed outside the raw water introduction hole to send the purified water which passes through the raw water distributor to the opening of the filter housing, and a concentrated water discharge hole that is formed in an opposite side of the purified water discharge hole to send the concentrated water discharged from the RO filter to the opening of the filter housing.

In order to accomplish the above objects, according to a further aspect, there is provided a side stream flow-type reverse osmosis membrane filter including:

a filter housing that is open at an upper end thereof;

an RO filter that is accommodated in the filter housing, purifies raw water which is introduced and sends purified water to an inside thereof, and discharges concentrated water which is filtered out to an outside thereof;

a central tube that is open at an upper end and a lower end thereof, is arranged in a center portion of the RO filter, and collects the purified water purified by the RO filter and introduced thereinto through passage holes formed to extend through a body thereof in a radial direction;

a raw water pipe that is arranged in the central tube to be spaced from an inner surface of the central tube, is open at an upper end and a lower end thereof, has a raw water flow channel at a center portion thereof, and defines a purified water flow channel formed between the raw water pipe and the central tube;

a flow channel switching guide installed in an opening of the filter housing and provided with a raw water introduction hole to supply raw water to an upper end of the RO filter and the raw water pipe, a purified water discharge hole which is ring-shaped and formed outside the raw water introduction hole to discharge the purified water filtered by the RO filter and collected in the purified water flow channel, and a concentrated water discharge hole which is ring-shaped and formed inside the raw water introduction hole to discharge the concentrated water filtered out by the RO filter; and

a raw water/purified water separator installed at the upper ends of the raw water pipe and the central tube, thereby supplying a portion of the raw water introduced through the upper end of the RO filter to the raw water flow channel and discharging the purified water collected in the purified water flow channel to the purified water discharge hole of the flow channel switching guide.

The raw water distributor is provided with:

a first channel through which a portion of the raw water introduced through the raw water port is supplied to the upper end of the raw water pipe, and

a second channel that communicates with the first channel and through which a portion of the raw water introduced into the first channel is supplied to the upper end of the RO filter.

The RO filter may be provided with:

an upper holder and a lower holder, wherein the upper holder is installed at the upper end of the RO filter and prevents the raw water supplied to the upper end of the RO filter through the raw water port and the raw water distributor from being mixed with the concentrated water discharged from the RO filter and sent to the concentrated water port, and wherein

the lower holder is installed at the lower end of the RO filter and prevents the raw water supplied to the lower end of the RO filter through the lower end of the raw water pipe from being mixed with the concentrated water discharged from the RO filter.

The RO filter may be provided with:

an upper holder and a lower holder wherein the upper holder is installed at the upper end of the RO filter and prevents the raw water supplied to the upper end of the RO filter through the raw water introduction hole and the raw water distributor from being mixed with the concentrated water discharged from the RO filter and sent to the concentrated water discharge hole, and wherein

the lower holder is installed at the lower end of the RO filter and prevents the raw water supplied to the lower end of the RO filter through the lower end of the raw water pipe from being mixed with the concentrated water discharged from the RO filter.

The RO filter may be provided with:

an upper holder and a lower holder when the upper holder is installed at the upper end of the RO filter and prevents the raw water supplied to the upper end of the RO filter through the raw water introduction hole of the flow channel switching guide from being mixed with the concentrated water discharged from the RO filter and sent to the concentrated water discharge hole, and wherein

the lower holder is installed at the lower end of the RO filter and prevents the raw water supplied to the lower end of the RO filter through the lower end of the raw water from being mixed with the concentrated water discharged from the RO filter and flowing in an outward direction.

The raw water/purified water separator may be provided with:

a first channel into which a portion of the raw water supplied to the upper end of the RO filter through the flow channel switching guide is introduced,

a second channel that communicates with the first channel and supplies the raw water introduced into the first channel to the upper end of the raw water pipe, and

a third channel that is formed outside the second channel and supplies the purified water collected in the purified water flow channel to the purified water discharge hole of the flow channel switching guide.

### Advantageous Effects

According to the present inventing described above, it is possible to increase a production amount of purified water by increasing a supply amount of raw water to a cylindrical reverse osmosis membrane sheet by supplying raw water to the respective ends of the cylindrical reverse osmosis membrane filter. Accordingly, practicality and marketability of a reverse osmosis membrane filter are improved.

In addition, since an end of a filter housing is provided with a raw water port, a purified water port, and a concentrated water port, it is easy for a worker to correctly connect hoses to the respective ports without mistakes, thereby improving workability.

In addition, since a filter housing that accommodates an RO filter therein can be attached to and detached from a head connector in a one-touch manner, a water purification filter can be easily replaced. Accordingly, the water purification filter can be conveniently used and reliability of the water purification filter is improved.

### DESCRIPTION OF DRAWINGS

FIG. 1 is a typical RO filter;

FIG. 2 is a cross-sectional view illustrating an RO filter according to a conventional art;

FIGS. 3a and 3b are cross-sectional views illustrating a side stream flow-type reverse osmosis membrane filter according to a first embodiment of the present invention;

FIG. 4 is a diagram illustrating a raw water distributor to distribute raw water introduced into a filter housing to an upper end and a lower end of an RO filter in the side stream flow-type reverse osmosis membrane filter according to the first embodiment;

FIGS. 5a and 5b are diagrams illustrating a side stream flow-type reverse osmosis membrane filter according to a second embodiment of the present invention in which a flow channel switching guide is installed in an opening of a filter housing;

FIGS. 6a and 6b are diagrams illustrating the flow channel switching guide of FIGS. 5a and 5b and a state in which the flow channel switching guide is combined with the raw water distributor;

FIGS. 7a and 7b are diagrams illustrating a state in which a head connector is combined with the filter housing of FIGS. 5a and 5b;

FIGS. 8a and 8b are diagrams illustrating a side stream flow-type reverse osmosis membrane filter according to a third embodiment of the present invention;

FIG. 9 is a diagram illustrating a flow channel switching guide of FIGS. 8a and 8b;

FIG. 10 is a diagram illustrating a raw water/purified water separator of FIGS. 8a and 8b; and

FIGS. 11a and 11b are diagrams illustrating a state in which a head connector is combined with a filter housing of FIGS. 8a and 8b.

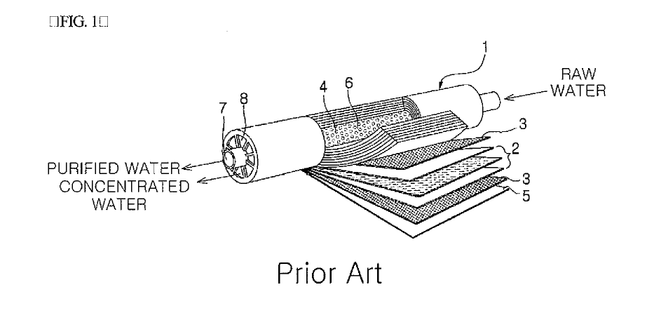

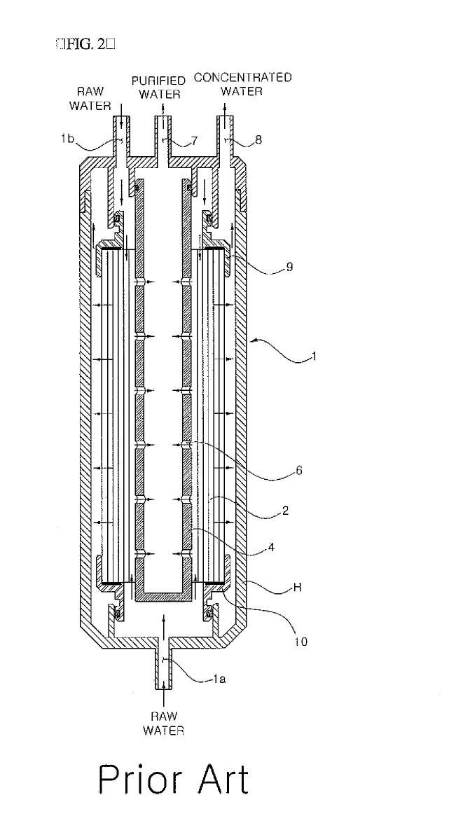

### DESCRIPTION OF THE REFERENCE NUMERALS IN THE DRAWINGS

11: Raw water port
12: Purified water port
13: Concentrated water port
14: Passage hole
15: RO filter
16: Central tube
17: Raw water pipe
18: Raw water flow channel
19: Purified water flow channel
20: Raw water distributor
21: First channel
22: Second channel
23: Raw water introduction hole
24: Purified water discharge hole
25: Concentrated water discharge hole
26: Flow channel switching guide
27: Raw water/purified water separator

### BEST MODE

Hereinafter, some side stream flow-type reverse osmosis membrane filters according to preferred embodiments of the present invention will be described with reference to the accompanying drawings.

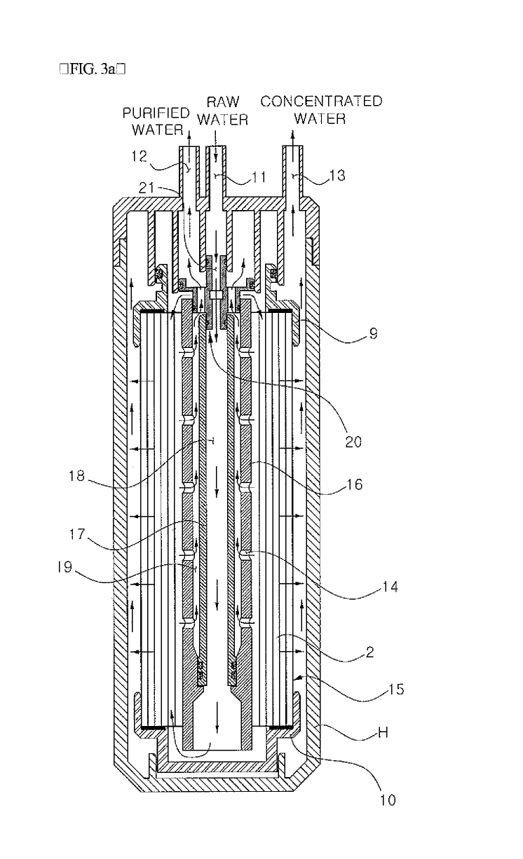

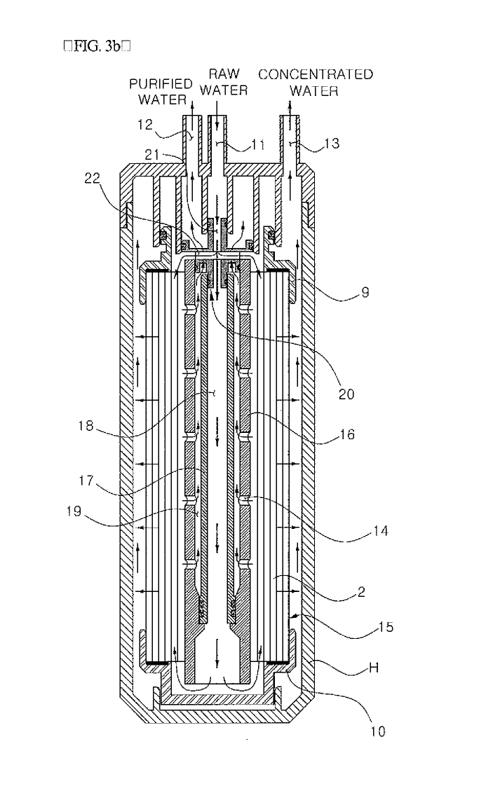

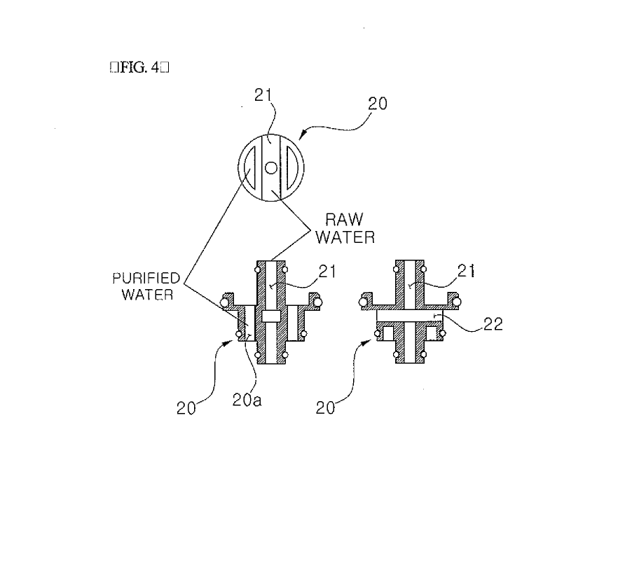

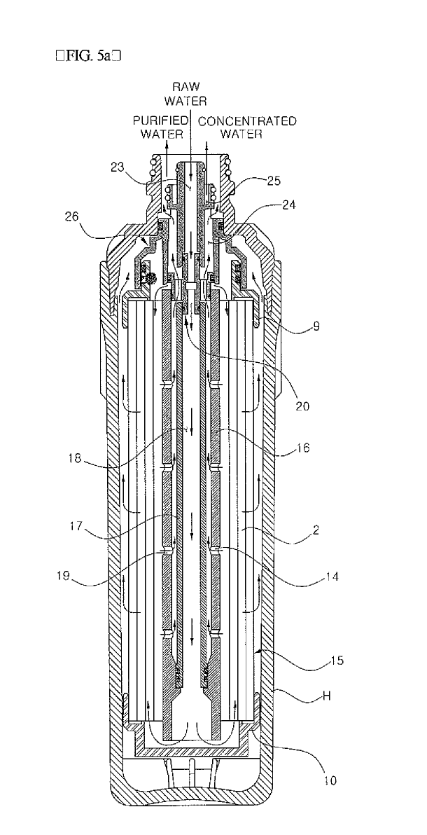

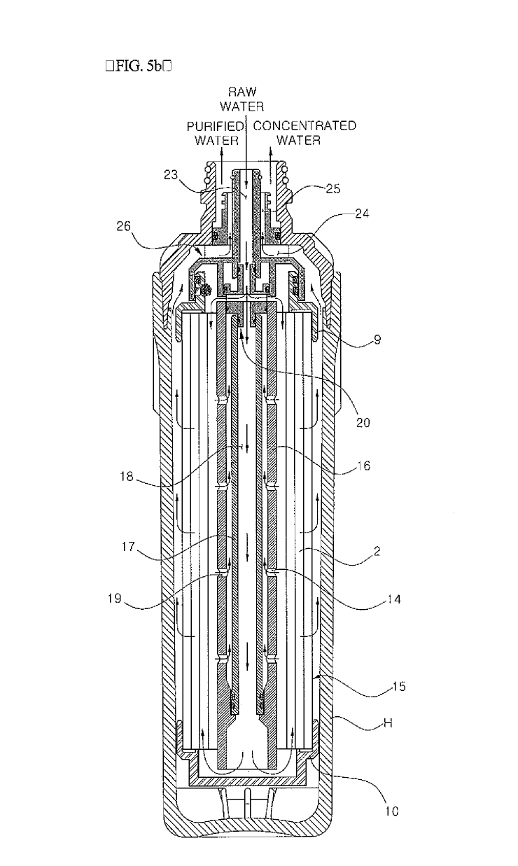

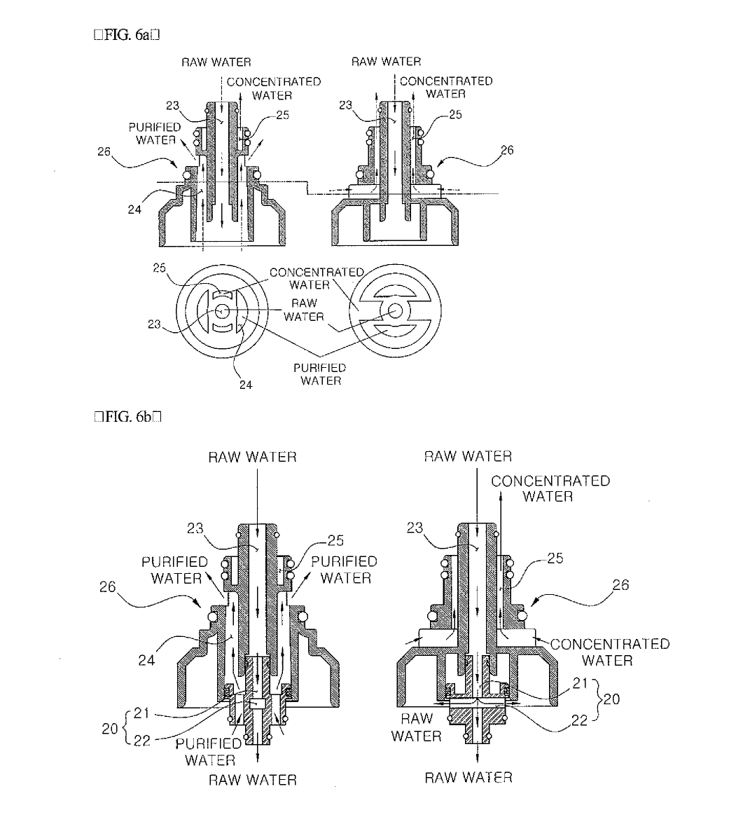

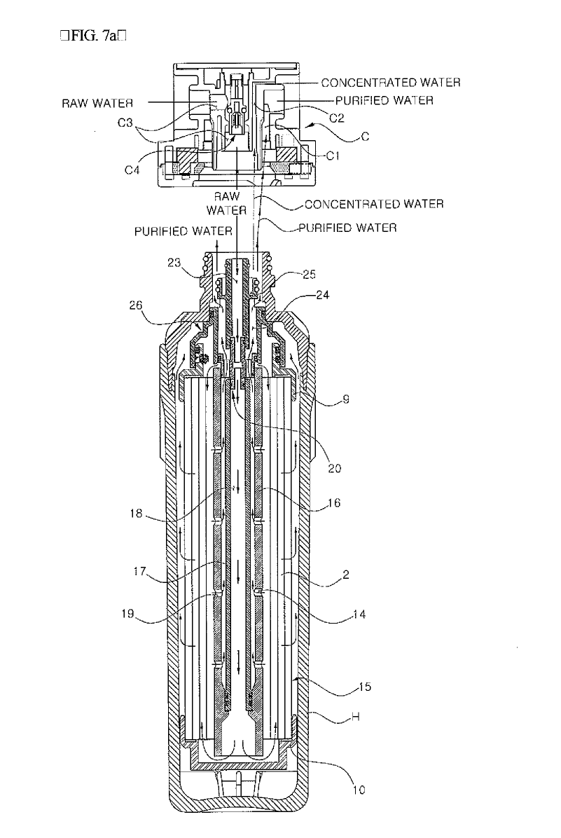

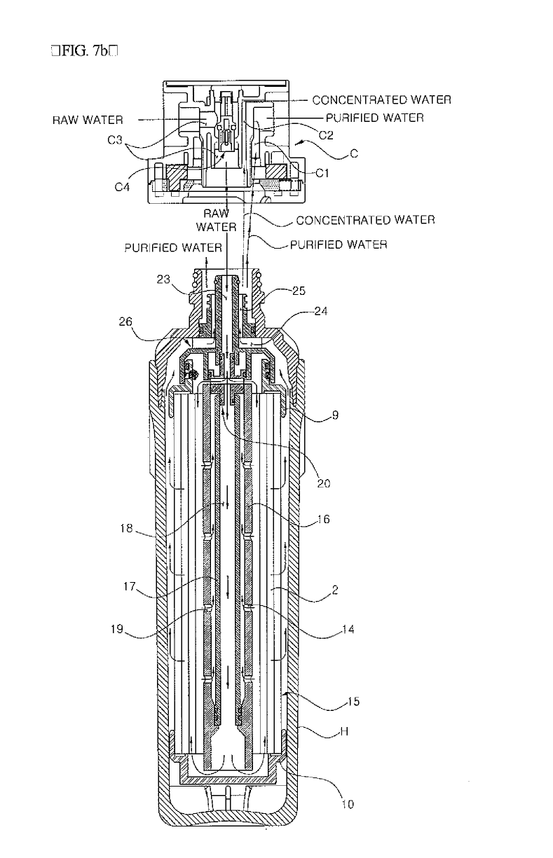

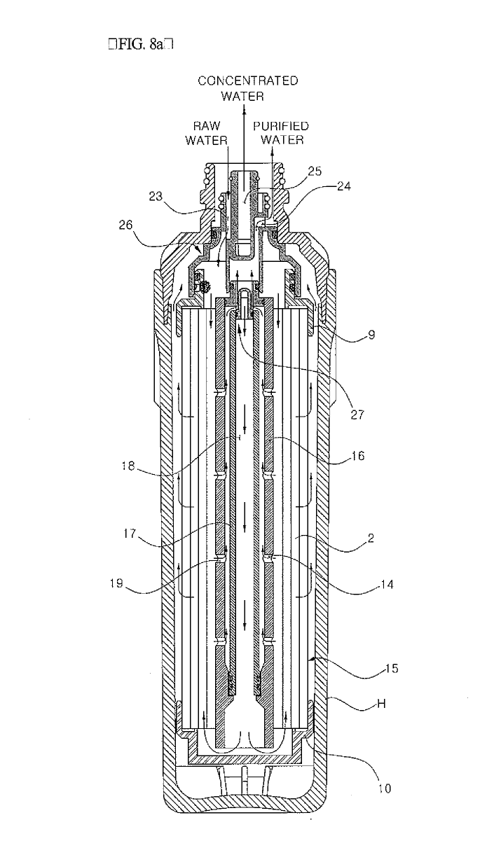

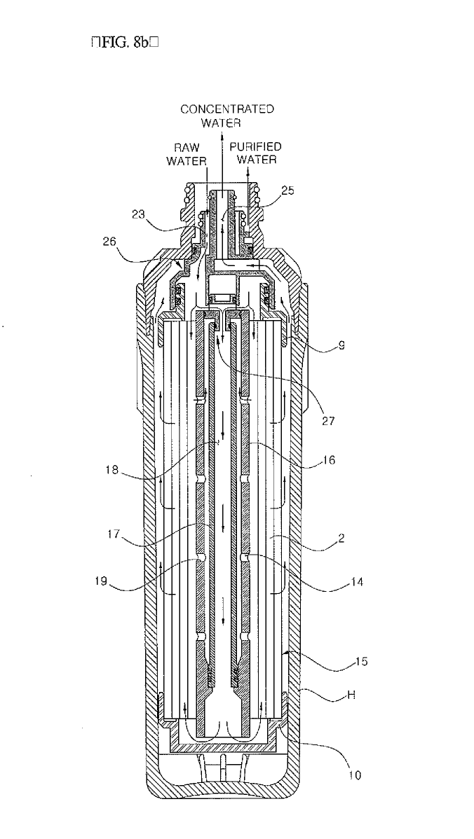

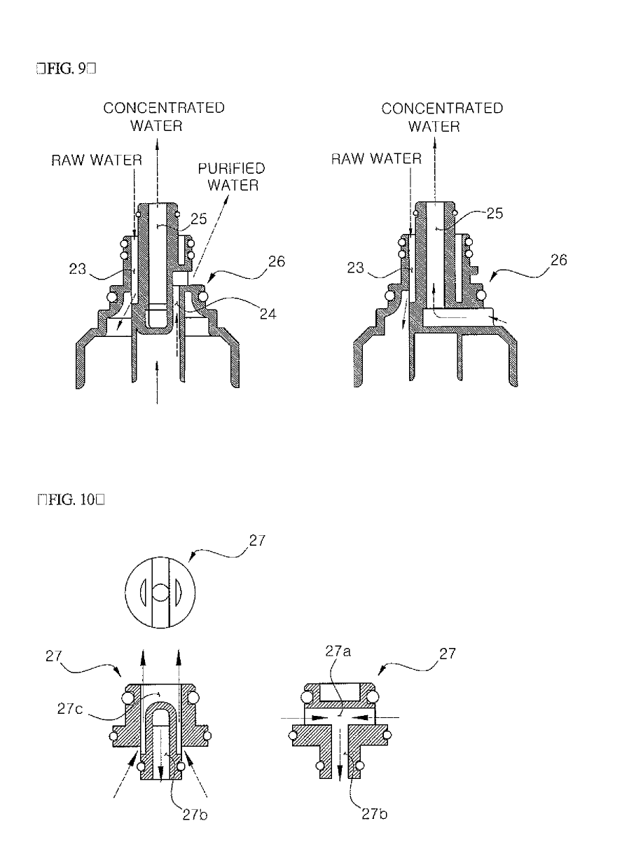

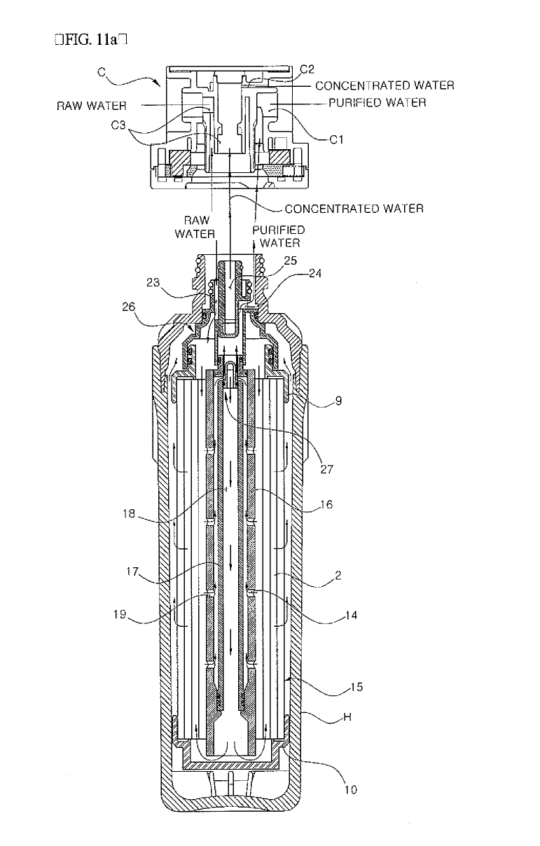

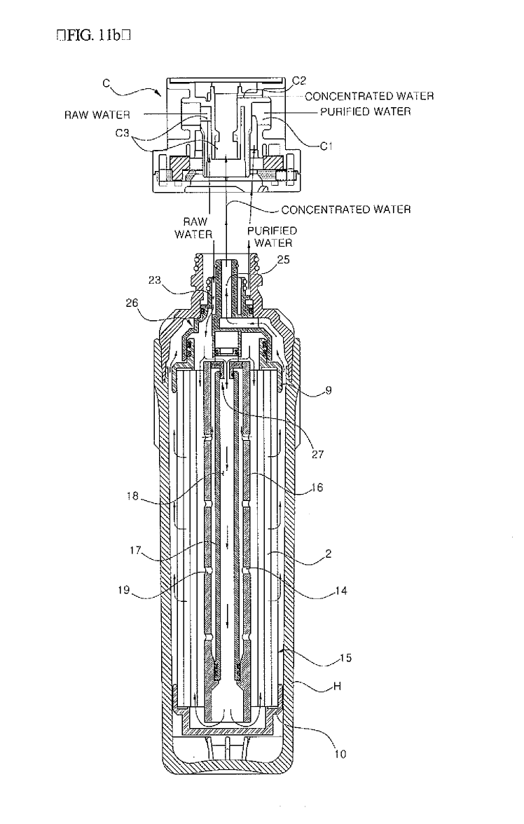

FIGS. 3a and 3b are cross-sectional views illustrating a side stream flow-type reverse osmosis membrane filter according to a first embodiment of the present invention; FIG. 4 is a diagram illustrating a raw water distributor to distribute raw water introduced into a filter housing to an upper end and a lower end of an RO filter in the side stream flow-type reverse osmosis membrane filter according to the first embodiment; FIGS. 5a and 5b are diagrams illustrating a side stream flow-type reverse osmosis membrane filter according to a second embodiment of the present invention in which a flow channel switching guide is installed at an opening of a filter housing; FIGS. 6a and 6b are diagrams illustrating the flow channel switching guide of FIGS. 5a and 5b and a state in which the flow channel switching guide is combined with the raw water distributor; FIGS. 7a and 7b are diagrams illustrating a state in which a head connector is combined with the filter housing of FIGS. 5a and 5b; FIGS. 8a and 8b are diagrams illustrating a side stream flow-type reverse osmosis membrane filter according to a third embodiment of the present invention; FIG. 9 is a diagram illustrating a flow channel switching guide of FIGS. 8a and 8b; FIG. 10 is a diagram illustrating a raw water/purified water separator of FIGS. 8a and 8b; and FIGS. 11a and 11b are diagrams illustrating a state in which a head connector is combined with a filter housing of FIGS. 8a and 8b.

With reference to FIGS. 3a and 3b and FIG. 4, the side stream flow-type reverse osmosis membrane filter according to the first embodiment of the present invention includes:

a filter housing H provided with a raw water port 11, a purified water port 12, and a concentrated water port 12 at an end of the filter housing;

an RO filter 15 that is accommodated in the filter housing H, purifies raw water introduced through the raw water port 11 with use of a membrane sheet 2, sends purified water to an inside thereof, and discharges concentrated water which is filtered out to an outside thereof;

a central tube 16 that is open at an upper end and a lower end thereof, is arranged in a center portion of the RO filter 15, and collects purified water which is purified by the RO filter 15 and introduced thereinto through passage holes 14 formed to extend through a body thereof in a radial direction;

a raw water pipe 17 that is open at an upper end and a lower end thereof, is arranged in the central tube 15 to be spaced from an inner surface of the central tube 15, has a raw water flow channel 18 in a center portion thereof, and defines a purified water flow channel 19 formed between the raw water pipe 17 and the central tube 16; and

a raw water distributor 20 installed at the upper ends of the raw water pipe 17 and the central tube 16, thereby supplying a portion of the raw water introduced through the raw water port 11 to an upper end of the RO filter 15 and a portion of the raw water introduced through the raw water port 11 to the raw water flow channel 18 of the raw water pipe 17 to supply it to a lower end of the RO filter 15 and sending the purified water collected in the purified water flow channel 19 to the purified water port 12 through a purified water flow hole 20a.

The raw water distributor 20 may be provided with:

a first channel 21 that supplies a portion of the raw water introduced through the raw water port 11 to an upper end of the raw water flow channel 18 of the raw water pipe 17 and

a second channel 22 that communicates with the first channel 21 and supplies a portion of the raw water introduced into the first channel 21 to the upper end of the RO filter 15.

The RO filter 15 may be provided with an upper holder 9 and a lower holder 10.

The upper holder 9 is installed at the upper end of the RO filter 15 and prevents the raw water which is supplied to the upper end of the RO filter 15 through the raw water port 11 and the raw water distributor 20 from being mixed with the concentrated water that is discharged from the RO filter 15 in the outward direction and sent to the concentrated water port 13.

The lower holder 10 is installed at the lower end of the RO filter 15 and prevents the raw water which is supplied to the lower end of the RO filter 15 through the lower end of the raw water pipe 17 from being mixed with the concentrated water which is discharged from the RO filter 15 in the outward direction.

In the drawings, reference character C denotes a head connector that is detachably connected to an opening of the filter housing H in a one-touch manner.

Hereinafter, an exemplary use of the side stream flow-type reverse osmosis membrane filter according to the first embodiment will be described in detail with reference to the accompanying drawings.

As illustrated in FIGS. 3a and 3b and FIG. 4, when raw water such as tap water is introduced into the filter housing H through the raw water port 11, a portion of the raw water is supplied to the upper end of the raw water pipe 17 through the first channel 21 of the raw water distributor 20. The supplied raw water flows down along the raw water flow channel 18 formed in the raw water pipe 17.

The raw water that reaches a lower end of the raw water flow channel 18 is introduced into the RO filter 15 through the lower end of the RO filter 15. Therefore, the raw water is purified while it is flowing upward in the drawings of FIGS. 3a and 3b.

A portion of the raw water introduced through the raw water port 11 is supplied to the upper end of the RO filter 15 through the second channel 22 that communicates with the first channel 21. Therefore, the raw water is purified by the membrane sheet 2 of the RO filter 15 while it is flowing downward in the drawings of FIGS. 3a and 3b.

The purified water that is produced by the membrane sheet 2 of the RO filter 15 passes through the passage holes 14 formed in the body of the central tube 16 arranged in the center portion of the RO filter 15. The purified water that passes through the passage holes 14 flows upward in the drawing through the purified water flow channel 19 formed between the raw water pipe 17 and the central tube 16.

The purified water that reaches an upper end of the purified water flow channel 19 passes through a purified water flow hole 20a of the raw water distributor 20 and then flows to an upper end portion of the filter housing H. The purified water passes through the purified water port 12 of the filter housing H after passing through the raw water distributor 20, and is finally discharged outside.

When the raw water that passes through the raw water distributor 20 flows into the RO filter 15 through the upper and lower ends of the RO filter 15, concentrated water that is filtered out by the membrane sheet 2 is produced. The concentrated water flows upward in the drawing through a channel disposed between the RO filter 15 and the filter housing H, thereby being discharged outside through the concentrated water port 13 of the filter housing H.

A portion of the raw water that passes through the raw water port 11 and flows into the filter housing H is supplied to the upper end of the RO filter 15 by the raw water distributor 20. A portion of the raw water introduced into the filter housing H is supplied to the lower end of the RO filter 15 by the raw water distributor 20 and the raw water pipe 17. Therefore, an amount of raw water supplied to the membrane sheet 2 of the RO filter 15 is increased, so that an amount of purified water produced by the RO filter 15 is increased.

With reference to FIGS. 5a and 5b through 7a and 7b, a side stream flow-type reverse osmosis membrane filter according to a second embodiment of the present invention includes:

a filer housing H that is open at an upper end thereof;

an RO filter 15 that is accommodated in the filter housing H, purifies raw water introduced through the raw water port 11 with use of a membrane sheet 2 and sends purified water to an inside thereof, and discharges concentrated water which is filtered out by the membrane sheet to an outside thereof;

a central tube 16 that is open at an upper end and a lower end thereof, is arranged in a center portion of the RO filter 15, and collects the purified water which is purified by the RO filter 15 and introduced thereinto through passage holes 14 formed to extend through a body thereof in a radial direction thereof;

a raw water pipe 17 that is open at an upper end and a lower end thereof, is arranged in the central tube 15 to be spaced from an inner surface of the central tube 15, has a raw water flow channel 18 in a center portion thereof, and defines a purified water flow channel 19 formed between the raw water pipe 17 and the central tube 16; and

a raw water distributor 20 installed at the upper ends of the raw water pipe 17 and the central tube 16, thereby supplying a portion of the raw water, which is introduced thereinto, to an upper end of the RO filter 15 and a portion of the raw water, which is introduced thereinto, to an upper end of the raw water flow channel 18 of the raw water pipe 17 to supply it to a lower end of the RO filter 15, and sending the purified water collected in the purified water flow channel 19 to an opening of the filter housing H (through a purified water discharge hole 24 of a flow channel switching guide 26 described below); and

the flow channel switching guide 26 that is installed in the opening of the filter housing H and provided with a raw water introduction hole 23, a purified water discharge hole 24, and a concentrated water discharge hole 25, wherein the raw water introduction hole 23 is formed in a center portion of the channel switching guide and supplies raw water to the first channel 21 of the raw water distributor 20, wherein the purified water discharge hole 24 is formed outside the raw water introduction hole 23 and sends the purified water that passes through the purified water flow hole 20a of the raw water distributor 20 to the opening of the filter housing H, and wherein the concentrated water discharge hole 25 is formed in the opposite side of the purified water discharge hole 24 and sends the concentrated water, discharged from the RO filter in an outward direction, to the opening of the filter housing H.

The RO filter 15 may be provided with an upper holder 9 and a lower holder 10.

The upper holder 9 is installed at the upper end of the RO filter 15 and prevents the raw water which is supplied to the upper end of the RO filter 15 through the raw water port 11 and the second channel 22 of the raw water distributor 20 from being mixed with the concentrated water which is discharged from the RO filter 15 in the outward direction and is sent to the concentrated water port 13.

The lower holder 10 is installed at the lower end of the RO filter 15 and prevents the raw water that passes through the lower end of the raw water flow channel 18 of the raw water pipe 17 and then reaches the lower end of the RO filter 15 from being mixed with the concentrated water that is discharged from the RO filter 15 in the outward direction.

Hereinbelow, an exemplary use of the side stream flow-type reverse osmosis membrane filter according to the second embodiment will be described in detail with reference to the accompanying drawings.

As illustrated in FIGS. 5a and 5b through 7a and 7b, the flow channel switching guide 26 provided with the raw water introduction hole 23, the purified water discharge hole 24, and the concentrated water discharge hole 25 is installed on the raw water distributor 20 and the upper holder 9 installed at the upper end of the RO filter 15.

When the opening of the filter housing H is connected to the head connector C, a check valve C4 that opens and closes a raw water channel C3 of the head connector C is lifted upward in the drawing by an upper end of the flow channel switching guide 26 so that the raw water channel C3 can be opened.

Raw water (tap water) introduced into the raw water channel C3 of the head connector C is supplied to the raw water introduction hole 23 of the flow channel switching guide 26. A portion of the raw water introduced through the raw water introduction hole 23 passes through the first channel 21 of the raw water distributor 20 and then flows to the upper end of the raw water flow channel 18 of the raw water pipe 17. The raw water that flows down to a lower end of the raw water flow channel 18 is supplied to the lower end of the RO filter 15.

For this reason, the raw water that flows along the RO filter 15 in an upward direction in the drawing is purified by the membrane sheet 2, and the purified water passes through the passage holes 14 of the central tube 16 to be collected in the purified water flow channel 19. In this case, it is possible to prevent the raw water supplied to the lower end of the RO filter 15 by the lower holder 10 installed at the lower end of the RO filter 15 from being mixed with the concentrated water that is discharged from the RO filter 15 in an outward direction.

On the other hand, a portion of the raw water introduced through the raw water introduction hole 23 is supplied to the upper end of the RO filter 15 through the second channel 22 of the raw water distributor 20. The raw water supplied to the upper end of the RO filter is purified by the membrane sheet 2 while the raw water is flowing downward in the drawing along the RO filter 15, and the purified water passes through the passage holes 14 of the central tube 16 to be collected in the purified water flow channel 19. In this case, it is possible to prevent the raw water supplied to the upper end of the RO filter 15 by the upper holder 9 installed at the upper end of the RO filter 15 from being mixed with the concentrated water that is filtered out by the RO filter 15 and sent to the opening of the filter housing H.

The purified water collected in the purified water flow channel 19 flows upward (in the drawing) and passes through the purified water flow hole 20a of the raw water distributor 20. Then the purified water passes through the purified water discharge hole 24 of the flow channel switching guide 26. Then, the purified water is discharged outside through the purified water channel C1 of the head connector C that is detachably connected to the opening of the filter housing H.

The concentrated water filtered out by the RO filter 15 flows upward (in the drawing) through a channel formed between the RO filter 15 and the filter housing H and then passes through the concentrated water discharge hole 25 of the flow channel switching guide 26. At this point, the concentrated water that reaches the concentrated water discharge hole 25 is discharged outside through the concentrated water channel C2 of the head connector C.

With reference to FIGS. 8a and 8b through 11a and 11b, a side stream flow-type reverse osmosis membrane filter according to a third embodiment of the present invention includes:

a filter housing H that is open at an upper end thereof;

an RO filter 15 that is accommodated in the filter housing, purifies raw water which is introduced thereinto and sends purified water to an inside thereof, and discharges concentrated water that is filtered out to an outside thereof;

a central tube 16 that is open at an upper end and a lower end thereof, is arranged in a center portion of the RO filter 15, and collects the purified water which is introduced thereinto through passage holes 14 formed to extend through a body thereof in a radial direction;

a raw water pipe 17 that is arranged in the central tube 16 to be spaced from an inner surface of the central tube, is open at an upper end and a lower end thereof, has a raw water flow channel 18 in a center portion thereof, and defines a purified water flow channel 19 formed between the raw water pipe 17 and the central tube 16;

a flow channel switching guide 26 that is installed in an opening of the filter housing H and provided with a raw water introduction hole 23, a purified water discharge hole 24, and a concentrated water discharge hole 25, wherein the raw water introduction hole 23 is used to supply raw water to an upper end of the RO filter and to the raw water pipe 17, wherein the purified water discharge hole 24 is ring-shaped and formed outside the raw water introduction hole 23 and is used to discharge the purified water which is purified by the RO filter 15 and collected in the purified water flow channel 19, and wherein the concentrated water discharge hole 25 is ring-shaped and formed inside the raw water introduction hole 23 and is used to discharge the concentrated water which is filtered out by the RO filter 15; and

a raw water/purified water separator 27 installed at the upper ends of the raw water pipe 17 and the central tube 16, wherein the raw water/purified water separator 27 supplies a portion of the raw water, supplied to the upper end of the RO filter 15, to the raw water flow channel 18 and sends the purified water, collected in the purified water flow channel 19, to the purified water discharge hole 24 of the flow channel switching guide 26.

The RO Filter 15 may be provided with an upper holder 9 and a lower holder 10.

The upper holder 9 is installed at the upper end of the RO filter 15 and prevents the raw water that is supplied to the upper end of the RO filter 15 through the raw water introduction hole 23 of the flow channel switching guide 26 from being mixed with the concentrated water that is sent to the concentrated water discharge hole 25.

The lower holder 10 is installed at the lower end of the RO filter 15 and prevents the raw water that is supplied to the lower end of the RO filter 15 through the lower end of the raw water flow channel 18 of the raw water pipe 17 from being mixed with the concentrated water that is discharged from the RO filter 15 and is sent to the concentrated water discharge hole 25.

The raw water/purified water separator 27 may be provided with:

a first channel 27a into which a portion of the raw water supplied to the upper end of the RO filter 15 through the flow channel switching guide 26 is introduced,

a second channel that communicates with the first channel 27a and supplies the raw water introduced into the first channel 27a to the upper end of the raw water flow channel 18 of the raw water pipe 17, and

a third channel 27c that is formed outside the second channel 27b and supplies the purified water collected in the purified water flow channel 19 to the purified water discharge hole 24 of the flow channel switching guide 26.

Hereinafter, an exemplary use of the side stream flow-type reverse osmosis membrane filter according to the third embodiment of the present invention will be described in detail with reference to the accompanying drawings.

With reference to FIGS. 8a and 8b through 11a and 11b, when the opening of the filter housing H is connected to the head connector C, the upper end of the flow channel switching guide 26 is connected to a concentrated water channel C2 formed in a center portion of the head connector C. Since the connection structure that detachably connects the head connector C to the filter H is already well known in the art, details thereof will not be described here.

The raw water introduced into the raw water channel C3 of the head connector C is supplied to the raw water introduction hole 23 of the flow channel switching guide 26. A portion of the raw water introduced through the raw water introduction hole 23 is supplied to the upper end of the RO filter 15 and a portion of the raw water introduced through the raw water introduction hole 23 passes sequentially through the first channel 27a and the second channel 27b of the raw water/purified water separator 27 and then flows into the raw water flow channel 18 of the raw water pipe 17.

Accordingly, the raw water supplied to the upper end of the RO filter 15 flows downward in the drawing along the RO filter 15 and is thus purified by the membrane sheet 2 while flowing down along the RO filter 15. The purified water passes through the passage holes 14 of the central tube 16 and collects in the purified water flow channel 19. The upper holder 9 installed at the upper end of the RO filter 15 prevents the raw water supplied to the upper end of the RO filter 15 from being mixed with the concentrated water that is filtered out by the RO filter 15 and sent to the concentrated water discharge hole 25 of the flow channel switching guide 26.

The purified water collected in the purified water flow channel 19 flows upward in the drawing and then passes through the third channel 27c of the raw water/purified water separator 27. After that, the purified water passes through the purified water discharge hole 24 of the flow channel switching guide 26. The purified water that passes through the purified water discharge hole 24 is discharged outside through the purified water channel C1 of the head connector C.

The concentrated water filtered out by the RO filter 15 is discharged in an outward direction of the RO filter 15. Then the concentrated water flows through a channel formed between the RO filter 15 and the filter housing H and reaches the concentrated water discharge hole 25 of the flow channel switching guide 26. The concentrated water that reaches the concentrated water discharge hole 25 is discharged outside through the concentrated water channel C2 of the head connector C.

The raw water that flows down through the raw water flow channel 18 is supplied to the lower end of the RO filter 15. Then, the raw water is purified by the membrane sheet 2 while flowing upward in the drawing along the RO filter 15. The purified water passes through the passage holes 14 of the central tube 16 and collects in the purified water flow channel 19. The lower holder 10 installed at the lower end of the RO filter 15 prevents the raw water supplied to the lower end of the RO filter 15 from being mixed with the concentrated water discharged from the RO filter 15.

Although preferred embodiments of the present invention have been described for illustrative purposes with reference to the accompanying drawings, those skilled in the art will appreciate that various modifications, additions and substitutions are possible, without departing from the scope and spirit of the invention as disclosed in the accompanying claims.

### INDUSTRIAL APPLICABILITY

According to the present invention described above, since raw water is supplied to respective ends of a cylindrical reverse osmosis membrane sheet, a supply amount of raw water to the reverse osmosis membrane sheet is increased. Therefore, a purified water recovery rate of a reverse osmosis membrane filter can be increased.

1. A side stream flow-type reverse osmosis membrane filter, comprising:
a filter housing an end of which is provided with a raw water port, a purified water port, and a concentrated water port;
an RO filter that is accommodated in the filter housing, purifies raw water introduced through the raw water port and sends purified water to an inside thereof, and discharges concentrated water which is filtered out to an outside thereof;
a central tube that is open at an upper end and a lower end thereof, is arranged in a center portion of the RO filter, and collects the purified water which is filtered by the RO filter and introduced into the central tube through passage holes formed to extend through a body thereof in a radial direction;
a raw water pipe that is arranged in the central tube to be spaced from an inner surface of the central tube, is open at an upper end and a lower end thereof, has a raw water flow channel in a center portion thereof, and defines a purified water flow channel formed between the raw water pipe and the central tube; and
a raw water distributor that is installed at the upper ends of the raw water pipe and the central tube, distributes raw water in a manner of supplying a portion of the raw water introduced through the raw water port to an upper end of the RO filter and a portion of the raw water introduced through the raw water port to the raw water pipe to supply the portion of the raw water to a lower end of the RO filter, and supplies the purified water collected in the purified water flow channel to the purified water port.

2. The side stream flow-type reverse osmosis membrane filter according to claim 1, wherein the raw water distributor is provided with a first channel that supplies a portion of the raw water, introduced through the raw water port, to the upper end of the raw water pipe and a second channel that communicates with the first channel and supplies a portion of the raw water, introduced into the first channel, to the upper end of the RO filter.

3. The side stream flow-type reverse osmosis membrane filter according to claim 1, wherein the RO filter is provided with an upper holder and a lower holder, wherein the upper holder is installed at the upper end of the RO filter and prevents the raw water supplied to the upper end of the RO filter through the raw water port and the raw water distributor from being mixed with the concentrated water that is discharged from the RO filter and sent to the concentrated water port, and wherein the lower holder is installed at the lower end of the RO filter and prevents the raw water supplied to the lower end of the RO filter through the lower end of the raw water pipe from being mixed with the concentrated water that is discharged from the RO filter.

4. A side stream flow-type reverse osmosis membrane filter comprising:
a filter housing that is open at an upper end thereof;
an RO filter that is accommodated in the filter housing, purifies raw water introduced into the filter housing and sends purified water to an inside thereof, and discharges concentrated water that is filtered out, to an outside thereof;
a central tube that is open at an upper end and a lower end thereof, is arranged in a center portion of the RO filter, and collects the purified water filtered by the RO filter and introduced thereinto through passage holes formed to extend through a body of the central tube in a radial direction;
a raw water pipe that is arranged in the central tube to be spaced from an inner surface of the central tube, is open at an upper end and a lower end thereof, has a raw water flow channel in a center portion thereof, and defines a purified water flow channel formed between the raw water pipe and the central tube;
a raw water distributer that is installed at the upper ends of the raw water pipe and the central tube, supplies a portion of the raw water, which is introduced thereinto, to an upper end of the RO filter and a portion of the raw water, which is introduced thereinto, to the raw water pipe to supply the portion of the raw water to a lower end of the RO filter, and sends the purified water collected in the purified water flow channel to an opening of the filter housing; and
a flow channel switching guide that is installed in the opening of the filter housing and is provided with a raw water introduction hole which is formed in a center portion thereof and supplies the introduced raw water to the raw water distributor, a purified water discharge hole which is formed outside the raw water introduction hole and sends the purified water which passes through the raw water distributor to the opening of the filter housing, and a concentrated water discharge hole which is formed in an opposite side of the purified water discharge hole and discharges outside the concentrated water discharged from the RO filter.

5. The side stream flow-type reverse osmosis membrane filter according to claim 4, wherein the RO filter is provided with an upper holder and a lower holder, wherein the upper holder is installed at the upper end of the RO filter and prevents the raw water supplied to the upper end of the RO filter through the raw water port and the raw water distributor from being mixed with the concentrated water that is discharged from the RO filter and sent to the concentrated water port, and wherein the lower holder is installed at the lower end of the RO filter and prevents the raw water supplied to the lower end of the RO filter through the lower end of the raw water pipe from being mixed with the concentrated water that is discharged from the RO filter.

6. A side stream flow-type reverse osmosis membrane filter comprising:
a filter housing that is open at an upper end thereof;
an RO filter that is accommodated in the filter housing, purifies raw water introduced into the filter housing and sends purified water to an inside thereof, and discharges concentrated water that is filtered out, to an outside thereof;
a central tube that is open at an upper end and a lower end thereof, is arranged in a center portion of the RO filter, and collects the purified water filtered by the RO filter and introduced thereinto through passage holes formed to extend through a body of the central tube in a radial direction;
a raw water pipe that is arranged in the central tube to be spaced from an inner surface of the central tube, is open at an upper end and a lower end thereof, has a raw water flow channel in a center portion thereof, and defines a purified water flow channel formed between the raw water pipe and the central tube;
a flow channel switching guide that is installed in an opening of the filter housing and is provided with a raw water introduction hole that supplies raw water to the upper end of the RO filter and the raw water pipe, a purified water discharge hole that is ring-shaped and formed outside the raw water introduction hole and discharges the purified water purified by the RO filter and collected in the purified water flow channel, and a concentrated water discharge hole that is ring-shaped and formed inside the raw water introduction hole and discharges the concentrated water which is filtered out by the RO filter; and
a raw water/purified water separator installed at the upper ends of the raw water pipe and the central tube, the raw water/purified water separator supplying a portion of the raw water supplied to the upper end of the RO filter to the raw water flow channel and discharging the purified water collected in the purified water flow channel to the purified water discharge hole of the flow channel switching guide.

7. The side stream flow-type reverse osmosis membrane filter according to claim 6, wherein the RO filter is provided with an upper holder and a lower holder, wherein the upper holder is installed at the upper end of the RO filter and prevents the raw water supplied to the upper end of the RO filter through the raw water introduction hole of the flow channel switching guide from being mixed with the concentrated water that is discharged from the RO filter and sent to the concentrated water discharge hole, and wherein the lower holder is installed at the lower end of the RO filter and prevents the raw water supplied to the lower end of the RO filter through the lower end of the raw water pipe from being mixed with the concentrated water which is discharged from the RO filter and flows in an outward direction of the RO filter.

8. The side stream flow-type reverse osmosis membrane filter according to claim 6, wherein the raw water/purified water separator has a first channel into which a portion of the raw water, supplied to the upper end of the RO filter through the flow channel switching guide, is introduced, a second channel that communicates with the first channel and supplies the raw water introduced into the first channel to the upper end of the raw water pipe, and a third channel that is formed outside the second channel and supplies the purified water collected in the purified water flow channel to the purified water discharge hole of the flow channel switching guide.
